(19) United States
(12) Patent Application Publication
(10) Pub. No.: US 2012/0038838 A1
(43) Pub. Date: Feb. 16, 2012

(54) FLAT SCREEN AND HOUSEHOLD APPLIANCE EQUIPPED THEREWITH

(75) Inventors: Hans Klaus Nussbächer, Munchen (DE); Eberhard Weidner, Nurnberg (DE)

(73) Assignee: BSH BOSCH UND SIEMENS HAUSGERÄTE GMBH, Munich (DE)

(21) Appl. No.: 13/266,273

(22) PCT Filed: Apr. 26, 2010
(86) PCT No.: PCT/EP2010/055536

§ 371 Date: Oct. 26, 2011

(30) Foreign Application Priority Data
May 14, 2009 (DE) 10 2009 003 125.1

(51) Int. Cl. G02F 1/1333

(52) U.S. Cl. 349/1; 349/58

(57) ABSTRACT

A flat screen includes an LCD matrix display element having a liquid crystal layer that is enclosed between a front pane on an observer side and a rear pane. Two metallic surfaces are arranged in opposition to one another at a distance in a viewing direction and connected to one another in a conducting manner. The metallic surfaces are disposed in front of the LCD matrix display element in the viewing direction and have overlapping openings, through which the LCD matrix display element is visible.

The present invention relates to a flat screen, which can be used in particular but not only in a household appliance. Such a screen can be used to display operating information relating to the household appliance for the user but can also display images that are not or at least not necessarily related to the operation of the household appliance, for example television programs or internet pages.

Many embodiments of flat screens with an LCD matrix display element are known. Conventionally they comprise an image field with two transparent panes, between which a liquid crystal layer is enclosed. Polarizing and in some instances color-filtering layers are configured on the panes. One of the panes also has a matrix of transparent electrodes to which a voltage can be applied individually, opposite which there is a similarly transparent ground coating on the other pane. The panes are enclosed at their edges by a generally metallic frame, which holds the panes together and protects their edges against damage due to impact from a lateral direction.

As light passes through the liquid crystal layer, its polarization is rotated to an extent which is a function of an electrical potential difference along the path and therefore of the electrical potential of an electrode the light crosses on its path. To control the potentials of a plurality of electrodes, high-frequency electrical signals are required, which are propagated on long conductor tracks across the display element, emitting considerable electromagnetic radiation in the process. Many display elements available on the market emit electromagnetic radiation to a degree that no longer complies with current legal requirements. When such display elements are incorporated in a flat screen, appropriate measures have to be taken to attenuate the radiation intensity in the environment of the screen.

One known measure for emission attenuation is the use of a cover pane, which is positioned between the matrix display element and an observer and is provided with a transparent, electrically conducting coating. Because the conducting coating is “grounded” on a metallic frame of the matrix display element, radiation emission in the direction of an observer can be reduced. However this is not sufficiently possible with every model of matrix display element to comply with the legal requirements.

The object of the invention is therefore to specify further measures for radiation attenuation at a flat screen that can be achieved with less outlay.

The object is achieved in that in a flat screen with an LCD matrix display element, which comprises a liquid crystal layer that is enclosed between a front pane on the observer side and a rear pane, two metallic surfaces, which lie opposite one another at a distance in the viewing direction and are connected to one another in a conducting manner, are disposed in front of the LCD matrix display element in the viewing direction and feature overlapping openings, through which the LCD matrix display element is visible. The opposing surfaces to a certain degree form two capacitor plates, which are excited to resonance over a wide band by electromagnetic emission of the display element and, because they are connected to one another in a conductive manner, dissipate the intercepted energy of the electromagnetic emission and prevent it from reaching the observer.

The width of the conductive surfaces, which extend around the overlapping openings in the manner of a strip, should preferably be at least 2 mm, more preferably 3 mm or more, to achieve effective shielding.

In order to achieve a locally evenly distributed attenuation effect, the conductive connection is expediently distributed along the edges of the surfaces.

The two metallic surfaces can be disposed on two faces of a cover pane in front of the LCD matrix display element. This ensures parallel alignment of the surfaces in a simple manner.

Permanent fixing of the metallic surfaces to the cover pane is not necessary; simple assembly is possible in particular in that at least one of the metallic surfaces is kept pressed against the cover pane by means of a clamp.

Shielding is further improved if the cover pane is provided with a transparent electrically conductive coating.

Because the conducting coating is “grounded”, the radiation emission in the direction of an observer can be reduced. A metallic contact strip positioned on the conductive coating is beneficial to establish good contact with a ground potential outside the cover pane.

If the front pane, the rear pane and the liquid crystal layer of the display element are enclosed in a metallic frame in a manner known per se, this frame can expediently be one of the abovementioned metallic surfaces.

A metallic tape that encloses the edges of the cover pane is excellently suited to establishing the distributed electrical contact between the opposing metallic surfaces.

At least one of the metallic surfaces can also then expediently be formed by a limb of the metallic tape folded over onto a main surface of the cover pane.

The metallic tape can also be used to touch the contact strip, thereby establishing an electrical connection to the conductive layer.

To achieve effective mechanical protection of the matrix display element by means of a fixed cover pane with minimal incorporated depth of the flat screen, it is expedient if a core zone of the cover pane is thicker than a peripheral zone, which overlaps with components of the enclosure of relevance for shielding, for example frame, contact strip or limbs of the metal tape.

The subject matter of the invention is also a household appliance, in particular a refrigeration appliance, having a flat screen of the type described above. Such a flat screen can in particular be positioned in the door of the household appliance, with an outer surface of the door preferably being formed in its entirety by a glass plate, behind which the flat screen is located.

Further features and advantages of the invention will emerge from the description which follows of exemplary embodiments with reference to the accompanying figures, in which:

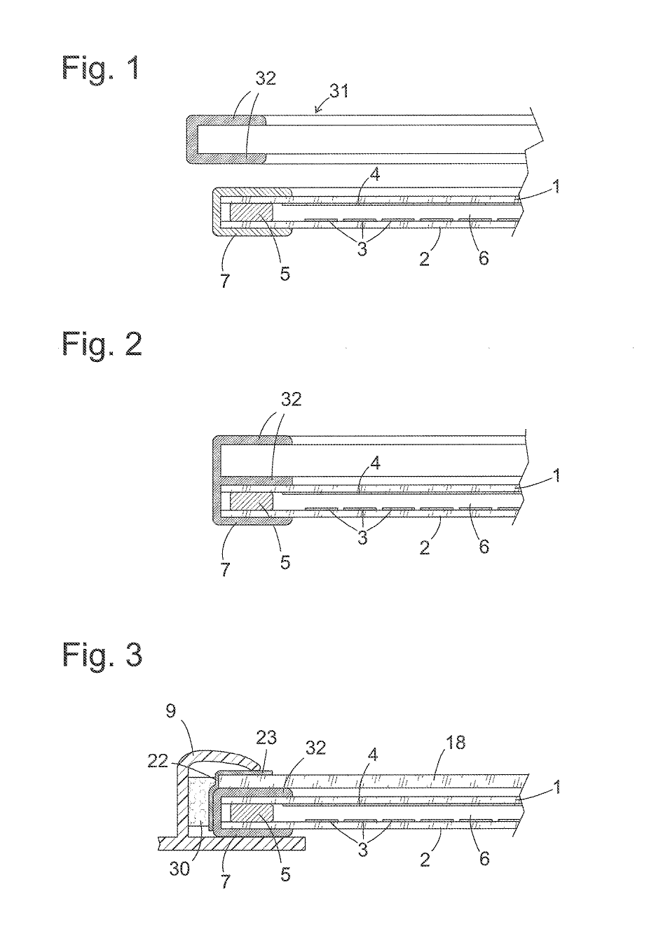

FIGS. 1 to 8 each show a partial section through a flat screen according to different embodiments of the invention; and

FIG. 9 shows a schematic perspective view of a refrigeration appliance having an incorporated flat screen.

FIG. 1 shows a cross section through the peripheral region of a flat screen according to a first embodiment of the invention. The side from which the screen can be observed is at the top in FIG. 1; a scatter surface irradiated by a light source, by which the screen is evenly illuminated from the rear and bottom, is not shown. Two panes 1, 2 made of mineral glass or a crystal-clear plastic material are provided with the standard coatings for LCD display elements, such as polarization coatings (not shown), individually activatable transparent pixel electrodes 3 and an unstructured ground electrode 4. The surface covered by the pixel electrodes 3 corresponds to the region of the screen that can be used to display images, also referred to here as the image field. In an intermediate space, which is kept free by spacers 5 and sealed at the sides, between the glass plates 1 is a liquid crystal solution 6. The rectangular glass plates 1, 2 are enclosed along their edges by a continuous frame 7, which is made up of U-profiles.

Further U-profiles 31 made of metal are shaped on a side facing the observer with opposing limbs 32 at a distance from one another in the viewing direction to form a frame, through the central opening of which the image field is visible. Radiation propagated from the display element in the viewing direction excites electrical oscillations between the limbs 32 of the frame that lie opposite one another in the manner of capacitor plates, extracting energy from the radiation.

FIG. 2 shows a flat screen with a simplified structure, in which the U-profiles 31 are fused to the, in this instance also metallic, frame 7 of the display element to form a metallic structure with an E-shaped cross section. Two limbs 32 of the structure, which are disposed in front of the outer glass plate 1, take on the function of capacitor plates here.

A preferred development is shown in FIG. 3. The display element with the plates 1, 2 and the metallic frame 7 is of a known, commercially available type. A cover pane 18 made of mineral glass or a crystal-clear plastic is kept pressed on a front limb 32 of the frame 7 facing an observer of the screen by a peripheral plastic enclosure 9, thereby covering the entire image field. An easily deformable thin metal tape 22 is held in close contact with the frame 7, which is C-shaped in cross section here, and the outside 19 of the cover pane 18, a limb 23 of the metal tape 22 resting on the cover pane 18 together with the limb 32 forming a pair of capacitor plates connected in a conducting manner. The metal tape 22 can be fitted at a later stage to any matrix display element enclosed in a metallic frame 7 with minimal outlay. Contact between the metal tape 22 and the frame 7 can be ensured by bonding with an electrically conductive bonding agent, or by soldering or, as shown here by an elastically compressed foam body 30 clamped between the enclosure 9 and the edges of the matrix display element. The enclosure 9 presses the limb 23 against the outer surface 19.

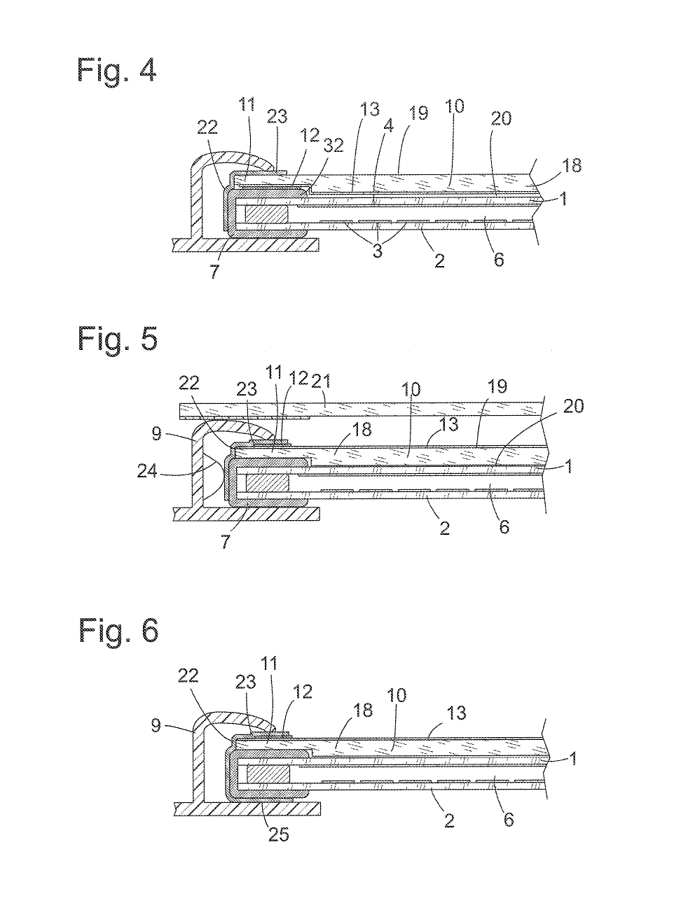

Shielding is further improved by a transparent, electrically conductive coating made of indium tin oxide, which is applied to a main surface of the cover pane 18. In the embodiment shown in FIG. 4 this coating 13 is on the inner face of the cover pane 18 facing the frame.

To achieve better electrical contact between the coating 13 and the frame 7 than is possible by means of direct contact and the pressure exerted by the enclosure 9, a metallic contact strip 12 is positioned on the coating 13 in a peripheral zone 11 of the cover pane 18 overlapping with the frame 7, to bring about the contact with the frame 7.

The peripheral zone 11 and core zone 10 of the cover pane 18 have a common flat outer surface 19, although the material thickness of the core zone 10 is greater than that of the peripheral zone 11 and the inner surface 15 of the core zone 10 projects into the frame 7 towards the display element. The core zone 10 of the cover pane 18 in FIG. 4 is therefore much more rigid than the one in FIG. 3, thereby offering more effective protection against damage due to impact by an object. The wall thicknesses of the core and peripheral zones 10, 11 are tailored to the dimensions of the frame 7, to maintain an air gap 20 between the cover pane 18 and the outer glass plate 1 of typically around 100 μm width. Such a distance is sufficient to prevent the occurrence of Newton's rings between the opposing surfaces of the outer pane 1 and the cover pane 18 but at the same time small enough for a reflection of the displayed image on the inner surface 15 not to be perceived by an observer with a problematic offset relative to the image displayed on the display element.

In a cover pane 18 with graduated thickness between the peripheral and core zones and a conductive coating 13 applied to the inner surface 15, as shown in FIG. 4, it is a complex procedure just to configure the contact strip 12 on part of the width of the peripheral zone 11. However since the core zone 10 is generally somewhat smaller than the exposed surface of the glass plates 1, 2 in the interior of the frame 7, there is a risk that the contact strip 12 will restrict the visible image if the entire exposed surface of the glass plates 1, 2 is used as the image field. If the contact strip is therefore only to extend over part of the width of the peripheral zone 11, it is expedient to position the conductive coating 13 and the contact strip 12 on the flat outer surface 19 of the cover pane 18, as shown in FIG. 5.

In the embodiment in FIG. 5 the contact strip 12 essentially forms the outer of the two capacitor plates and the limb 23 of the metal tape 22 folded onto the outside of the cover pane 18 serves to establish good contact between the contact strip 12 and the frame 7 by way of the narrow sides of the cover pane 18.

To protect the external coating 13 from wear, a further scratch-resistant coating, known from eye glasses for example, can be applied to said coating 13. The further coating may be omitted, if the entire flat screen, as illustrated in FIG. 5, is incorporated for its part behind a transparent pane 21 of an appliance housing. This pane 21 is expediently provided with a non-reflective coating, since otherwise, because of its distance of several mm from the matrix display element, reflections occurring at its surfaces could be perceived separately from the actual image by an observer looking at the screen from a direction away from the surface normal.

In the embodiment in FIG. 6 the metal tape 22 not only has a limb 23 pressed against the contact strip 12 on the outside of the cover pane 18 but also a limb 25 held clamped between the enclosure 9 and a rear face of the frame opposite this.

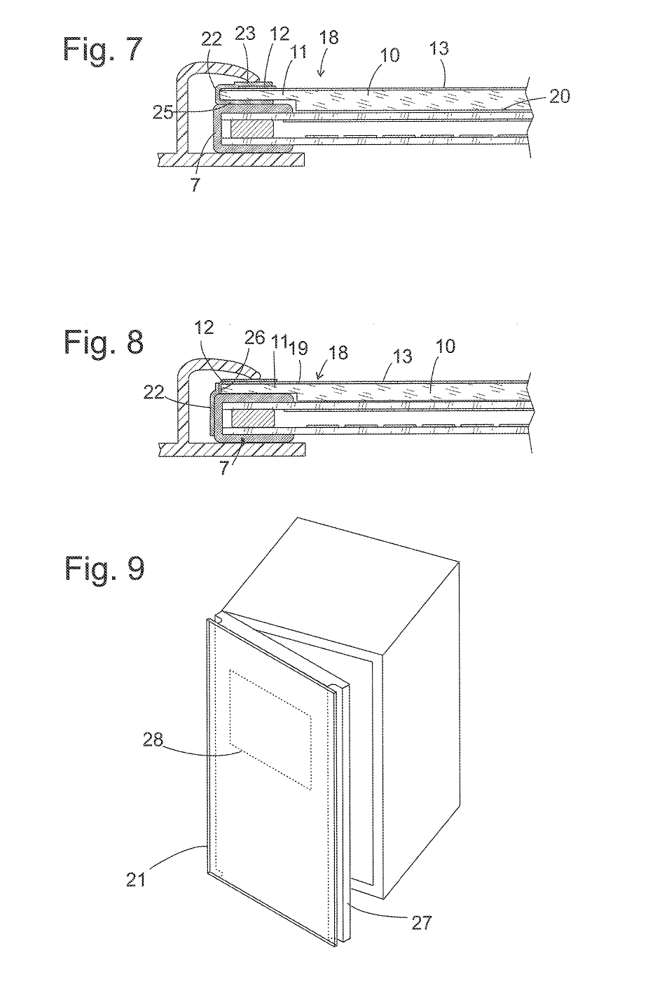

According to a modification shown in FIG. 7 a second limb 25 of the metal tape 22 can also be clamped between the peripheral zone 11 of the cover pane 18 and the front face of the frame 7. This allows the thickness of the core zone 10 to be increased by the material thickness of the metal tape 22 whilst still maintaining the width of the air gap 20, thereby making the cover pane 18 more rigid.

It is also possible to position the contact strip 12, as illustrated in FIG. 8, not only on one of the main surfaces of the cover pane 18 but also along its narrow sides 26. This allows extensive, low-resistance electrical contact to be established between the contact strip 12 and the frame 7, as in FIG. 3 by means of a metal tape 22 which does not have an angled limb but simply extends along the outside of the frame 7 and the narrow sides 26 of the cover pane 18.

FIG. 9 shows a refrigeration appliance as one example of the application of the flat screen, the flat screen being incorporated in the front face of the door 27 here. The entire front face of the door 27 is taken up by a glass plate 21, which like the pane 21 in FIG. 4 covers the entire flat screen. The glass plate 21 is printed in a non-transparent manner on its rear face, with the exception of a central blank space 28, behind which the flat screen is positioned. The edges of this blank space 28 correspond precisely to the region of the plates 1, 2 used for the image display, so that the frame 7 and the peripheral zone 11 of the cover pane 18 and together with these also the contact strip 12 and where applicable the metal tape 22 are concealed.

1-15. (canceled)

16. A flat screen, comprising:
an LCD matrix display element comprising a liquid crystal layer that is enclosed between a front pane on an observer side and a rear pane; and
two metallic surfaces arranged in opposition to one another at a distance in a viewing direction and connected to one another in a conducting manner, said metallic surfaces being disposed in front of the LCD matrix display element in the viewing direction and having overlapping openings, through which the LCD matrix display element is visible.

17. The flat screen of claim 16, wherein the metallic surfaces extend around the overlapping openings in the manner of a strip and have a width which is at least 2 mm.

18. The flat screen of claim 16, wherein the metallic surfaces extend around the overlapping openings in the manner of a strip and have a width which is 3 mm or more.

19. The flat screen of claim 16, wherein the surfaces are connected by a conductive connection which is distributed along edges of the surfaces.

20. The flat screen of claim 16, further comprising a cover pane disposed in front of the LCD matrix display element, said two metallic surfaces being disposed on two faces of the cover pane.

21. The flat screen of claim 20, further comprising a clamp to keep at least one of the metallic surfaces pressed against the cover pane.

22. The flat screen of claim 20, wherein the cover pane is provided with a transparent electrically conductive coating.

23. The flat screen of claim 22, wherein one of the metallic surfaces is formed by a metallic contact strip positioned on the conductive coating.

24. The flat screen of claim 16, wherein one of the metallic surfaces is formed by a metallic frame, in which the front pane, the rear pane and the liquid crystal layer are enclosed.

25. The flat screen of claim 20, further comprising a metallic tape, which encloses edges of the cover pane.

26. The flat screen of claim 25, wherein at least one of the metallic surfaces is formed by a limb of the metallic tape.

27. The flat screen of claim 25, further comprising a metallic frame, in which the front pane, the rear pane and the liquid crystal layer are enclosed, wherein the metallic tape touches the metallic frame in a conducting manner.

28. The flat screen of claim 23, further comprising a metallic tape, which encloses edges of the cover pane, said metallic tape touching the contact strip in a conducting manner.

29. The flat screen of claim 20, wherein the cover pane has a core zone which has a thickness which is greater than a thickness of a peripheral zone of the cover pane.

30. A household appliance, comprising a flat screen having an LCD matrix display element comprising a liquid crystal layer that is enclosed between a front pane on an observer side and a rear pane, and two metallic surfaces arranged in opposition to one another at a distance in a viewing direction and connected to one another in a conducting manner, said metallic surfaces being disposed in front of the LCD matrix display element in the viewing direction and having overlapping openings, through which the LCD matrix display element is visible.

31. The household appliance of claim 30, constructed in the form of a refrigeration appliance.

32. The household appliance of claim 30, further comprising a door having an outer surface which is formed by a glass plate, said flat screen being positioned behind the glass plate.

33. The household appliance of claim 30, wherein the metallic surfaces extend around the overlapping openings in the manner of a strip and have a width which is at least 2 mm.

34. The household appliance of claim 30, wherein the metallic surfaces extend around the overlapping openings in the manner of a strip and have a width which is 3 mm or more.

35. The household appliance of claim 30, wherein the surfaces are connected by a conductive connection which is distributed along edges of the surfaces.

36. The household appliance of claim 30, further comprising a cover pane disposed in front of the LCD matrix display element, said two metallic surfaces being disposed on two faces of the cover pane.

37. The household appliance of claim 36, further comprising a clamp to keep at least one of the metallic surfaces pressed against the cover pane.

38. The household appliance of claim 36, wherein the cover pane is provided with a transparent electrically conductive coating.

39. The household appliance of claim 38, wherein one of the metallic surfaces is formed by a metallic contact strip positioned on the conductive coating.

40. The household appliance of claim 30, wherein one of the metallic surfaces is formed by a metallic frame, in which the front pane, the rear pane and the liquid crystal layer are enclosed.

41. The household appliance of claim 36, further comprising a metallic tape, which encloses edges of the cover pane.

42. The household appliance of claim 41, wherein at least one of the metallic surfaces is formed by a limb of the metallic tape.

43. The household appliance of claim 41, further comprising a metallic frame, in which the front pane, the rear pane and the liquid crystal layer are enclosed, wherein the metallic tape touches the metallic frame in a conducting manner.

44. The household appliance of claim 39, further comprising a metallic tape, which encloses edges of the cover pane, said metallic tape touching the contact strip in a conducting manner.

45. The household appliance of claim 36, wherein the cover pane has a core zone which has a thickness which is greater than a thickness of a peripheral zone of the cover pane.
